(19) United States
(12) Patent Application Publication
(10) Pub. No.: US 2025/0357510 A1
(43) Pub. Date: Nov. 20, 2025

(54) FUEL CELL LOAD SPLIT MANAGEMENT

(71) Applicant: Caterpillar Inc., Peoria, IL (US)

(72) Inventors: Jacqueline D. KARL-DEFRAIN, Peoria Heights, IL (US); Shivangi WAGLE, Peoria, IL (US); Ramya Vyas ARVIND, Dunlap, IL (US)

(73) Assignee: Caterpillar Inc., Peoria, IL (US)

(21) Appl. No.: 18/664,249

(22) Filed: May 14, 2024

(51) Int. Cl. H01M 8/04537; H01M 8/04992

(52) U.S. Cl. CPC H01M 8/04619; H01M 8/04992

(57) ABSTRACT

In some implementations, a power management controller may receive a total power request including a total power value. The power management controller may compare the total power value to a threshold. The power management controller may select between an equal load split mode or a cascaded load split mode based on the total power value. The equal load split mode may be selected if the total power value is above the threshold and the cascaded load split mode may be selected if the total power value is below the threshold.

### TECHNICAL FIELD

The present disclosure relates generally to managing fuel cell load split and, for example, to selecting between an equal load split or a cascaded load split for parallel fuel cells.

### BACKGROUND

Fuel cells are devices that convert chemical energy from a fuel into electricity through a chemical reaction with oxygen or another oxidizing agent. Historically, fuel cells have been used in a variety of applications, ranging from power generation in industrial settings to providing energy for spacecraft. Fuel cells are categorized by the type of electrolyte they use, which can include polymer electrolyte membrane (PEM) fuel cells, solid oxide fuel cells (SOFC), and molten carbonate fuel cells (MCFC), among others.

German Patent Application Publication No. 102021132603A1 (“the '603 publication”) discloses a method for optimizing the operating parameters of an arrangement with a first fuel cell system and with a second fuel cell system, each of which has a fuel cell stack. The method also relates to an arrangement with a first fuel cell system and with at least one second fuel cell system, each of which has a fuel cell stack with a plurality of fuel cells. The '603 publication discloses that the maximum power value for the first fuel cell system can be determined during operation of the arrangement, and thus a change in the best point of the fuel cell system can be detected.

The '603 publication, however, fails to appreciate circumstances where switching between an equal load split and a cascaded load split may be beneficial to the fuel cells in the fuel cell stack. For example, the arrangement disclosed in the '603 publication is unable to maintain minimum power and may experience excessive startups and shutdowns, which may damage the fuel cell stack. Moreover, the'603 publication fails to appreciate how fault scenarios may affect the fuel cell load split optimization. As such, the fuel cells of the '603 publication may experience unbalanced aging, unwanted energy losses (parasitics), unoptimized power distribution in fault scenarios, and/or a combination thereof, among other examples.

The power management controller of the present disclosure solves one or more of the problems set forth above and/or other problems in the art.

### SUMMARY

A method may include receiving a total power request including a total power value; comparing the total power value to a threshold; and selecting between an equal load split mode or a cascaded load split mode based on the total power value, the equal load split mode being selected if the total power value is above the threshold and the cascaded load split mode being selected if the total power value is below the threshold.

A fuel cell system may include a first fuel cell; a second fuel cell in parallel with the first fuel cell; and a power management controller operatively coupled to the first fuel cell and the second fuel cell, the power management controller being configured to select between an equal load split mode or a cascaded load split mode based on a power value, the equal load split mode being selected if the power value is above a threshold and the cascaded load split mode being selected if the power value is below the threshold.

A power management controller may include one or more memories; and one or more processors, communicatively coupled to the one or more memories, configured to: receive a total power request including a total power value; compare the total power value to a threshold; select one of an equal load split mode or a cascaded load split mode based on the total power value, the equal load split mode being selected if the total power value is above the threshold and the cascaded load split mode being selected if the total power value is below the threshold; and request power output by a first fuel cell and by a second fuel cell in accordance with one of the equal load split mode or the cascaded load split mode.

### BRIEF DESCRIPTION OF THE DRAWINGS

FIG. 1 is a diagram of an example fuel cell system that may be used in, for example, fuel cell stationary power generation.

FIG. 2 is a diagram of an example fuel cell bank including a first fuel cell, a second fuel cell, a third fuel cell, and a power management controller.

FIG. 3 is a flowchart of an example process associated with fuel cell load split management.

### DETAILED DESCRIPTION

This disclosure relates to a power management controller, which is applicable to implementations involving fuel cell stationary power generation. The power management controller may also be incorporated into a machine that performs an operation associated with an industry, such as mining, construction, farming, transportation, or any other industry. For example, the machine may be an electric vehicle, an electric work machine (e.g., a compactor machine, a paving machine, a cold planer, a grading machine, a backhoe loader, a wheel loader, a harvester, an excavator, a motor grader, a skid steer loader, a tractor, and/or a dozer), or an energy storage system, among other examples.

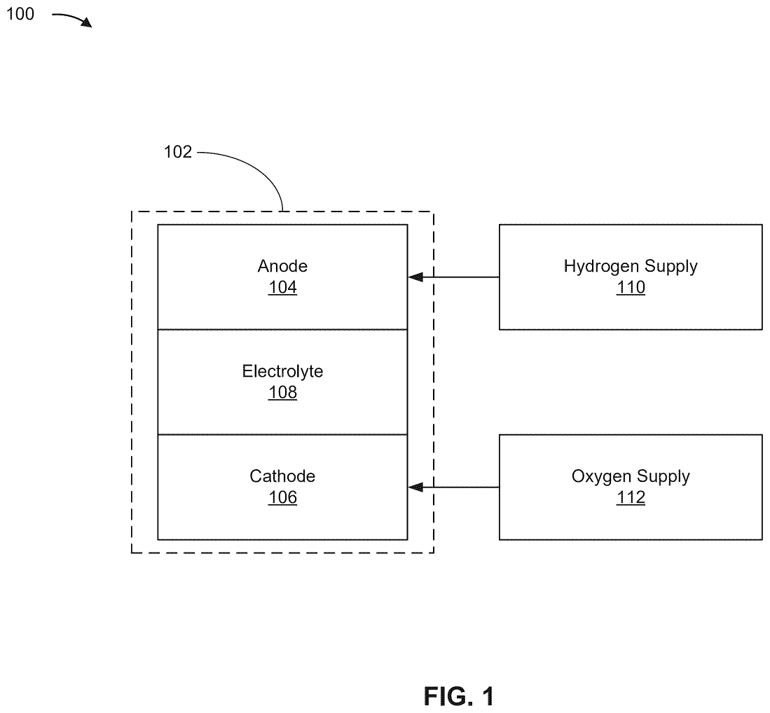

FIG. 1 is a diagram of an example fuel cell system 100 that may be used in, for example, stationary power generation. The fuel cell system 100 may include a fuel cell 102 including an anode 104, a cathode 106, an electrolyte 108, a hydrogen supply 110, and an oxygen supply 112.

The anode 104 may be one of the primary electrodes in the fuel cell 102. The anode 104 may facilitate the oxidation of the fuel in the fuel cell 102. For example, in a hydrogen fuel cell, hydrogen gas (H₂) may be introduced to the anode 104. A catalyst may be used to split the hydrogen molecules into protons (H⁺) and electrons (e⁻) through an oxidation process. The electrons produced may travel through an external load toward the cathode 106. This movement of the electrons from the anode 104 to the cathode 106 may create an electric current.

The cathode 106 may be the part of the fuel cell 102 where a reduction reaction occurs. For example, in a hydrogen fuel cell, once the electrons have traveled through the external load from the anode 104, the electrons may arrive at the cathode 106 where the oxygen may be present. At the cathode 106, the electrons may combine with the oxygen and with protons (which have traveled through the electrolyte 108 from the anode 104) to form water. This reduction process may result in a continuous flow of electrons from the anode 104 to the cathode 106, which may generate a continuous electric current that may be used to, for example, power a generator.

The electrolyte 108 may be used to conduct charged ions from one electrode to another, completing the electrochemical circuit within the fuel cell 102. As discussed above, in a hydrogen fuel cell, after the hydrogen gas is split at the anode 104 into protons and electrons, the protons (H⁺) may travel through the electrolyte 108 to the cathode 106 where they combine with oxygen and electrons to form water. The electrolyte 108 may act as a barrier to the electrons, forcing the electrons to travel through the external load, thereby producing electric power. The electrolyte 108 may further serve as a physical barrier that may separate the fuel (e.g., hydrogen) from the oxidant (e.g., oxygen) to prevent the fuels from mixing and combusting prematurely. The electrolyte 108 may be disposed between the anode 104 and the cathode 106 within the fuel cell 102. Depending on the type of fuel cell, the electrolyte 108 may take the form of a proton exchange membrane, a liquid solution of potassium hydroxide, a hard ceramic compound, a liquid salt, a phosphoric acid, and/or a combination thereof, among other examples.

The hydrogen supply 110 may refer to the source of hydrogen gas provided to the anode 104. As discussed above, with respect to a hydrogen fuel cell, hydrogen acts as the fuel that undergoes electrochemical reactions to produce electricity. This hydrogen may be stored as compressed gaseous hydrogen in the hydrogen supply 110. The hydrogen supply 110 may be implemented as a storage tank (e.g., a high pressure tank made of a material such as a carbon fiber-reinforced polymer), a reformer, and/or a combination thereof, among other examples.

The oxygen supply 112 may refer to the source of oxygen that is provided to the cathode 106. As discussed above, with respect to a hydrogen fuel cell, oxygen acts as the oxidizing agent. The oxygen may come from the ambient air, although sometimes pure oxygen, stored in an oxygen tank, may be used instead of or in addition to oxygen in the ambient air. When the oxygen supply 112 includes ambient air, the ambient air may be filtered, for example, to remove at least some nitrogen and possibly other gases.

As discussed above, the byproduct of the fuel cell 102 is water. The water may be exhausted from the fuel cell 102, may be stored in a reservoir, may evaporate, may be recycled (e.g., electrolyzed to produce oxygen and/or hydrogen), and/or a combination thereof, among other examples.

As indicated above, FIG. 1 is provided as an example. Other examples are possible and may differ from what was described in connection with FIG. 1.

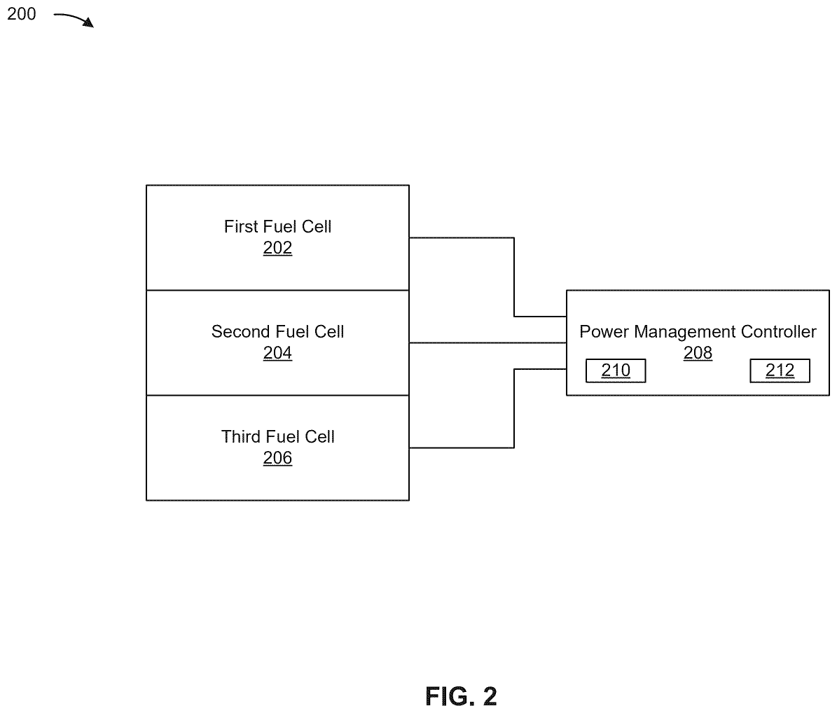

FIG. 2 is a diagram of an example fuel cell bank 200 including a first fuel cell 202, a second fuel cell 204, a third fuel cell 206, and a power management controller 208. The first fuel cell 202, the second fuel cell 204, and the third fuel cell 206 may each be a fuel cell, such as the fuel cell 102, described above with respect to FIG. 1. The first fuel cell 202, the second fuel cell 204, and the third fuel cell 206 may be electrically arranged in parallel to one another and may be referred to collectively as “the fuel cells.”

The power management controller 208 may be implemented as a circuit, chip, or other electronic device configured to regulate the operations of the fuel cells. The power management controller 208 may include one or more memories 210 and one or more processors 212 communicatively coupled to the one or more memories 210. The processors may be configured, individually or collectively, to monitor and adjusts parameter such as fuel flow, temperature, and electrical output of the first fuel cell 202, the second fuel cell 204, and the third fuel cell 206 in real-time. The power management controller 208 may be configured to cause the fuel cells in the fuel cell bank 200 to operate in an equal load split mode or a cascaded load split mode. For example, the power management controller 208 may be configured to receive a total power request, indicating a total power value (e.g., an amount of power needed for a particular load) and select one of the equal split mode or the cascaded split mode based on the total power request. The power management controller may be configured to compare the total power request to a threshold and select between the equal load split mode or the cascaded load split mode based on whether or not the total power value indicated by the total power request exceeds the threshold. If the total power value exceeds the threshold, the power management controller 208 may be configured to select the equal load split mode. If the total power value is below the threshold, the power management controller 208 may be configured to select the cascaded load split mode.

When operating in the equal split mode, the power management controller 208 may request that the fuel cells each provide the same power output. For example, the power management controller 208 may transmit an equal power request to each of the fuel cells, and the equal power request may cause each of the fuel cells to output the same amount of power indicated by an equal power value. The equal power value indicated by the equal power request may be based on the total power value indicated by the total power request.

When operating in the cascaded load split mode, the power management controller 208 may command two or more of the first fuel cell 202, the second fuel cell 204, and/or the third fuel cell 206 to provide different power outputs. For example, the power management controller 208 may be configured to transmit a first power request, indicating a first power value, to the first fuel cell 202. The power management controller 208 may be further configured to transmit a second power request, indicating a second power value, to the second fuel cell 204. Likewise, the power management controller 208 may be configured to transmit a third power request, indicating a third power value to the third fuel cell 206. The first power value may be different from or the same as the second power value and/or the third power value. The second power value may be the same as or different from the third power value. The first power value may be based on a saturation characteristic of the first fuel cell 202. The second power value may be based on a saturation characteristic of the second fuel cell 204. The third power value may be based on a saturation characteristic of the third fuel cell 206.

The power management controller 208 may be configured to prioritize the fuel cells when operating in the cascaded load split mode. The priority of each fuel cell may be based on factors such as the availability of the fuel cell, the saturation characteristics of the fuel cell, the age of the fuel cell, and/or a combination thereof, among other examples. The power management controller 208 may be configured to transmit power requests to each of the fuel cells in order of priority. For example, if the first fuel cell 202 has the highest priority and the second fuel cell 204 has the second highest priority, the power management controller 208 may be configured to transmit the first power request to the first fuel cell and the second power request to the second fuel cell. In this example, the first power request may indicate a first power value higher than the second power value indicated by the second power request. Moreover, in this example, the first power value may be based on a saturation characteristic of the first fuel cell 202. For instance, the first power value may cause the first fuel cell 202 to output the total power up to a maximum output power of the first fuel cell 202. If additional power is needed (e.g., the total power is greater than the maximum output power of the first fuel cell 202), the power management controller 208 may be configured to transmit the second power request, indicating the second power value, to the second fuel cell 204. As discussed above, the second power value may be based on a saturation value of the second fuel cell 204. For instance, the second power value may cause the second fuel cell 204 to contribute to the output of the total power, but the second power value may be limited by a maximum output power of the second fuel cell 204. If additional power is needed (e.g., the total power is greater than the maximum output power of the first fuel cell 202 and the second fuel cell 204), the power management controller 208 may be configured to transmit the third power request, indicating the third power value, to the third fuel cell 206. Additional fuel cells, in parallel with the first fuel cell 202, the second fuel cell 204, and the third fuel cell 206, may be commanded to output power as needed until the output of the fuel cell system is equal to the total power demanded by the load.

The power management controller 208 may be configured to provide a closed loop slow proportional-integral (PI) tune adjustment. For example, the power management controller 208 may be configured to make gradual adjustments to the proportional and integral parts of the control system, based on closed-loop feedback, to operate the fuel cells 202, 204, 206 in a more stable and efficient manner. For instance, the power management controller 208 may be configured to continuously monitor and adjusts operation (e.g., cascaded and load-split operations) based on feedback received. The power management controller 208 may be configured to monitor parameters such as temperature, pressure, and flow rates, and the power management controller 208 may adjust the operation of the fuel cells 202, 204, 206 accordingly (including switching between the cascaded load split and equal load split operations) to maintain or improve performance. The adjustments may be “slow” to avoid instability or inefficiency. For example, the power management controller 208 may make gradual adjustments to the fuel cells 202, 204, 206 to avoid overshoot. With respect to the PI tune adjustment, the power management controller 208 may be configured to control the fuel cells 202, 204, 206 in proportion to the error (e.g., proportional control based on a difference between a set point and a measured value) and in accordance with the accumulation of past errors (e.g., integral control). The PI control may reduce or eliminate steady state errors. Tuning the proportional control and integral control may involve adjusting their respective parameters in a way that improves fuel cell response, which can result in more efficient operation, maintained stability, and improved response to changes in demand or operating conditions.

The power management controller 208 may be configured to detect a fault scenario. A fault scenario may refer to any situation where a fuel cell is unable to provide an expected output. The power management controller 208 may be configured to reprioritize the fuel cells in response to detecting a fault scenario. Alternatively or in addition, the power management controller 208 may be configured to modify the first power request, the second power request, the third power request, and/or a combination thereof, among other examples, as a result of detecting the fault scenario. For example, if the power management controller 208 detects a fault scenario associated with the first fuel cell 202, resulting in a reduced power output of the fuel cell system, the power management controller 208 may be configured to request an updated power output by the second fuel cell 204 and/or the third fuel cell 206 to compensate for the reduced total power output. The power management controller 208 may be configured to request the updated power output by transmitting an updated second power request to the second fuel cell 204, an updated third power request to the third fuel cell 206, and/or a combination thereof, among other examples. When a fault scenario occurs with respect to the first fuel cell 202, the power management controller 208 may be configured to request the updated power output from the second fuel cell 204 and the third fuel cell 206 in accordance with the equal load split mode or the cascaded load split mode.

As indicated above, FIG. 2 is provided as an example. Other examples are possible and may differ from what was described in connection with FIG. 2.

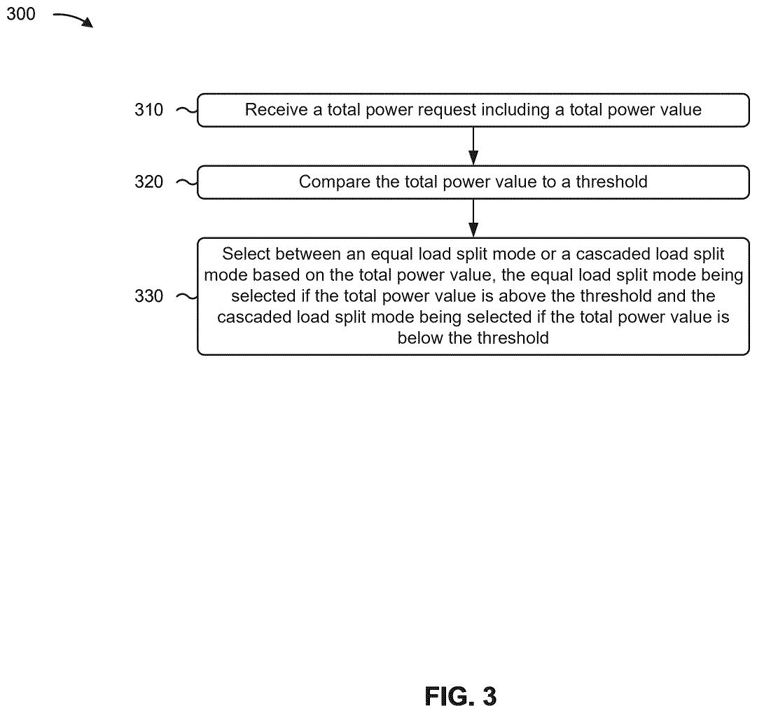

FIG. 3 is a flowchart of an example process 300 associated with fuel cell load split management. One or more process blocks of FIG. 3 may be performed by a power management controller (e.g., power management controller 208). Additionally, or alternatively, one or more process blocks of FIG. 3 may be performed by another device or a group of devices separate from or including the power management controller, such as another device or component that is internal or external to a fuel cell system.

As shown in FIG. 3, process 300 may include receiving a total power request including a total power value (block 310). For example, the power management controller may receive a total power request including a total power value, as described above.

As further shown in FIG. 3, process 300 may include comparing the total power value to a threshold (block 320). For example, the power management controller may compare the total power value to a threshold, as described above.

As further shown in FIG. 3, process 300 may include selecting between an equal load split mode or a cascaded load split mode based on the total power value, the equal load split mode being selected if the total power value is above the threshold and the cascaded load split mode being selected if the total power value is below the threshold (block 330). For example, the power management controller may select between an equal load split mode or a cascaded load split mode based on the total power value, the equal load split mode being selected if the total power value is above the threshold and the cascaded load split mode being selected if the total power value is below the threshold, as described above.

Process 300 may include detecting a fault scenario associated with a first fuel cell, and requesting power output by a second fuel cell in accordance with the equal load split mode or the cascaded load split mode as a result of the fault scenario. Process 300 may include requesting power output by a third fuel cell in accordance with the equal load split mode or the cascaded load split mode as a result of the fault scenario.

Process 300 may include requesting power output by a first fuel cell and by a second fuel cell in accordance with one of the equal load split mode or the cascaded load split mode. Requesting power output by the first fuel cell and by the second fuel cell in accordance with the equal load split mode may include transmitting an equal power request to the first fuel cell and to the second fuel cell. Requesting power output by the first fuel cell and by the second fuel cell in accordance with the cascaded load split mode may include transmitting a first power request to the first fuel cell, and transmitting a second power request to the second fuel cell. The first power request may indicate a first power value based on a saturation characteristic of the first fuel cell, and the first power value may be lower than the total power value. The second power request may indicate a second power value lower than the first power value. The second power request may be based on a saturation characteristic of the second fuel cell.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

### INDUSTRIAL APPLICABILITY

In fuel cell systems with parallel fuel cells, such as fuel cell stationary power generation, switching between an equal load split mode and a cascaded load split mode based on a total power request can provide various benefits. For example, operating the fuel cell system in a cascaded load split mode when the total power request is below a threshold and operating the fuel cell system in an equal load split mode can result in more balanced aging, reduce unwanted energy losses (parasitics), optimize power generation in fault scenarios, and/or a combination thereof, among other examples.

What is claimed is:

1. A method, comprising:
receiving a total power request including a total power value;
comparing the total power value to a threshold; and
selecting between an equal load split mode or a cascaded load split mode based on the total power value,
the equal load split mode being selected if the total power value is above the threshold and the cascaded load split mode being selected if the total power value is below the threshold.

2. The method of claim 1, further comprising:
detecting a fault scenario associated with a first fuel cell; and
requesting power output by a second fuel cell in accordance with the equal load split mode or the cascaded load split mode as a result of the fault scenario.

3. The method of claim 2, further comprising requesting power output by a third fuel cell in accordance with the equal load split mode or the cascaded load split mode as a result of the fault scenario.

4. The method of claim 1, further comprising requesting power output by a first fuel cell and by a second fuel cell in accordance with one of the equal load split mode or the cascaded load split mode.

5. The method of claim 4, wherein requesting power output by the first fuel cell and by the second fuel cell in accordance with the equal load split mode includes transmitting an equal power request to the first fuel cell and to the second fuel cell.

6. The method of claim 4, wherein requesting power output by the first fuel cell and by the second fuel cell in accordance with the cascaded load split mode includes:
transmitting a first power request to the first fuel cell; and
transmitting a second power request to the second fuel cell.

7. The method of claim 6, wherein the first power request indicates a first power value based on a saturation characteristic of the first fuel cell, and
wherein the first power value is lower than the total power value.

8. The method of claim 7, wherein the second power request indicates a second power value lower than the first power value.

9. The method of claim 6, wherein the second power request is based on a saturation characteristic of the second fuel cell.

10. A fuel cell system, comprising:
a first fuel cell;
a second fuel cell in parallel with the first fuel cell; and
a power management controller operatively coupled to the first fuel cell and the second fuel cell,
the power management controller being configured to select between an equal load split mode or a cascaded load split mode based on a power value,
the equal load split mode being selected if the power value is above a threshold and the cascaded load split mode being selected if the power value is below the threshold.

11. The fuel cell system of claim 10, wherein the power management controller is operatively connected to a third fuel cell.

12. The fuel cell system of claim 11, wherein the power management controller is configured to:
detect a fault scenario associated with the first fuel cell; and
request power output by the second fuel cell and by the third fuel cell as a result of detecting the fault scenario.

13. The fuel cell system of claim 12, wherein the power management controller is configured to request power output by the second fuel cell and by the third fuel cell in accordance with one of the equal load split mode or the cascaded load split mode.

14. The fuel cell system of claim 10, wherein the power management controller is configured to adjust a power output of one or more of the first fuel cell or the second fuel cell in accordance with a closed loop slow proportional-integral tune adjustment.

15. The fuel cell system of claim 10, wherein the power management controller is configured to transmit an equal power request to the first fuel cell and to the second fuel cell in accordance with the equal load split mode.

16. The fuel cell system of claim 10, wherein the power management controller is configured, in accordance with the cascaded load split mode, to:
transmit a first power request, indicating a first power value, to the first fuel cell; and
transmit a second power request, indicating a second power value lower than the first power value, to the second fuel cell.

17. A power management controller, comprising:
one or more memories; and
one or more processors, communicatively coupled to the one or more memories, configured to:
receive a total power request including a total power value;
compare the total power value to a threshold;
select one of an equal load split mode or a cascaded load split mode based on the total power value,
the equal load split mode being selected if the total power value is above the threshold and the cascaded load split mode being selected if the total power value is below the threshold; and
request power output by a first fuel cell and by a second fuel cell in accordance with one of the equal load split mode or the cascaded load split mode.

18. The power management controller of claim 17, wherein the one or more processors are configured to:
detect a fault scenario associated with the first fuel cell; and
request power output by the second fuel cell and to a third fuel cell in accordance with the equal load split mode or the cascaded load split mode as a result of the fault scenario.

19. The power management controller of claim 17, wherein the one or more processors are configured to transmit an equal power request to the first fuel cell and to the second fuel cell in accordance with the equal load split mode.

20. The power management controller of claim 17, wherein the one or more processors are configured to request power output by the first fuel cell and by the second fuel cell in accordance with the cascaded load split mode by being configured to:
transmit a first power request, indicating a first power value, to the first fuel cell; and
transmit a second power request, indicating a second power value lower than the first power value, to the second fuel cell.
